(19) United States
(12) Patent Application Publication
(10) Pub. No.: US 2003/0229543 A1
(43) Pub. Date: Dec. 11, 2003

(54) Centralized management of packaging data with rule-based content validation

(76) Inventors: Shannon M. Zimmerman, River Falls, WI (US); Joseph R. Bechtel, River Falls, WI (US); Michael R. Haldane, Savage, MN (US)

Correspondence Address: 3M INNOVATIVE PROPERTIES COMPANY, PO BOX 33427, ST. PAUL, MN, 55133-3427, US

(21) Appl. No.: 10/167,968

(22) Filed: Jun. 10, 2002

(51) Int. Cl. G06F 17/60

(52) U.S. Cl. 705/26

(57) ABSTRACT

A central packaging data (CPD) management system provides an online environment in which customers manage packaging data for their products. The CPD management system securely distributes the packaging data to respective remote manufacturing sites, print centers or other output locations, and allows the customers to easily control the printed output material applied to their packaging and manufactured products. The CPD management system includes a variety of features for the application of business rules to automate the generation and validation of packaging materials.

### TECHNICAL FIELD

The invention generally relates to manufacturing technologies and, more particularly, generating labeling and other printed material for packages.

### BACKGROUND

Each year, organizations ranging from sole proprietorships to large corporations produce and ship significant volumes of diverse products. The products, as well as the containers in which they are shipped, typically bear a variety of labels and other printed packaging materials. Each product may use a different container, requiring printed packaging material of different size and shape. In addition, a manufactured product may incorporate many packaging levels from the time the product comes off the manufacturing line to shipment. Furthermore, the format and content of the labels at each level may be highly regulated, as in the health care and pharmaceutical industries.

Large companies may use a number of different software tools, such as graphics design and layout packages, to create and print the packaging materials. Coordination of the various packaging materials used throughout an organization, and ensuring compliance with labeling regulations across all of the products, can present a significant challenge for the organization.

### SUMMARY

In general, the invention is directed to techniques for centralized management, assembly, and distribution of packing data. A system is described in which a centralized packaging data (CPD) management system provides host packaging data for a plurality of customers, and provides an online environment with which the customers manage packaging data for their products. The customers interact with the CPD management system to assemble packaging data, and securely distribute the packaging data to respective remote manufacturing sites, print centers or other output locations. In this manner, the system allows the customers to easily control the printed output material applied to their packaging and manufactured products.

The CPD management system includes a variety of features for the application of business rules to automate the generation and validation of packaging materials. In particular, the CPD management system provides interfaces for the automated retrieval of regulation and compliance information from external data sources, such as regulatory agencies, shipping companies, and global customs. A rules engine applies rules to validate the content of labels or other packaging material, thereby ensuring compliance with the regulations. In addition, the customers can create additional rules to ensure that the packaging materials satisfy their particular requirements.

Furthermore, the CPD management system allows the customers to easily customize and select packaging templates for quickly assembling packaging data based on the regulations. Customers can hierarchically organize the templates to reflect the requirements of their specific businesses. In this manner, the CPD management system provides an intelligent packaging data warehouse with which the customers interact for creation, validation, and distribution of packaging data for labels and other packaging materials associated with products.

In one embodiment, a system comprises a set of packaging records and associated packaging data for a plurality of products, and a rules engine to validate the packaging records and associated data in accordance with a set of rules.

In another embodiment, a medium comprises a set of packaging records and associated packaging data for a plurality of products for a plurality of customers, and a set of reusable packaging templates having data fields for creation of the packaging records in response to input from the customers. The medium further comprises a set of rules for validation of the packaging records.

In another embodiment, a system comprises a template manager software interface to create and manage a set of reusable packaging templates for a plurality of customers, wherein the template manager software interface registers the packaging templates against nodes of customer-defined hierarchies for organizing the packaging templates. The system further comprises a record manager software interface to create and manage a set of packaging records based on the packaging templates, wherein the record manager software interface presents subsets of the packaging templates based on the hierarchical relationship of the packaging templates.

In another embodiment, a method comprises hierarchically relating a set of reusable packaging templates having data fields, and selectively presenting a subset of the packaging templates to a user based on the hierarchical relationship of the packaging templates. The method further comprises selecting one of the presented packaging templates in response to input from the user, and generating a packaging record that associates packaging data with the fields of the selected packaging template.

In another embodiment, an online packaging data management system comprises means for centrally storing packaging templates and packaging records for a plurality of customers, means for associating packaging data with the packaging templates, and means for validating the packaging records and associated packaging data in accordance with a set of rules defining packaging requirements. The system further comprises means for controlling updates to the packaging templates and the packaging records, and means for printing packaging materials at output locations in accordance with the packaging records.

These and other embodiments, including other systems, methods and computer-readable mediums that store instructions and data, are described in the specification and claims below. The invention may provide one or more advantages, including allowing customers to develop a common management process across business units and manufacturing sites and, therefore, eliminate redundancies and inefficiencies inherent to a decentralized process.

The customer may, for example, readily develop and manage standardized graphics for the various business units, allowing the company to provide more consistency and accuracy in the appearance of labels entering distribution channels and customer markets. The CPD management system provides a centralized workspace by which users can collaborate to design and create labels and other printed material for new packages, and can reduce cycle times by facilitating the reuse of existing packaging templates and graphics. In addition, the CPD management system includes a variety of features for the application of business rules and other constraints to automate the generation and validation of packaging materials, thereby ensuring compliance with regulations.

Furthermore, the CPD management system allows a customer to more easily control and manage the packaging data, including the various sizes, layouts, and formats of the output mediums on which the packaging data are printed. In particular, multiple output locations, such as manufacturing facilities and print centers, receive the same packaging data and, therefore, can print identical labels and other print material for packages and manufactured products. The system also provides an efficient mechanism for rapid propagation of changes throughout an organization.

Another advantage of a CPD management system is the ability to support relocation of products from one facility to another. In other words, because packaging data may be centrally managed, a company can relocate products from one manufacturing facility to another without needing to transfer labeling information. This process may be difficult with conventional desktop graphic design tools that execute on independent workstations.

The CPD management system provides revision control modules for developing and maintaining packaging data. The system, for example, includes mechanisms for checking in and checking out packaging templates and graphics. The system may track modifications of labels and provide revision histories and other modification information.

Another advantage provided by the CPD management system is to support and facilitate “on-demand” print systems by streamlining the delivery of packaging data to such systems when needed. In other words, packaging data can be quickly distributed to print systems when a company decides to manufacture a product, thereby allowing the company to satisfy any “just-in-time” manufacturing and supply contracts and other business relationships the company may service. In addition, the system supports “run-time” fields that require information at the time of print, such as batch code, lot code, manufacture data, serial number and the like.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example centralized packaging data (CPD) management system that host packaging data for a plurality of customers.

FIG. 2 is a block diagram illustrating the CPD management system of FIG. 1 in further detail.

FIG. 3 is a flowchart that provides a high-level overview of example operation of the central management system.

FIG. 4 is a block diagram proving another high-level overview of the operation of the CPD management system

FIG. 5 illustrates example hierarchies for organizing packaging templates and business rules within the CPD management system.

FIG. 6A is a block diagram illustrating an example schema for storing packaging data for a plurality of customers within a database server.

FIG. 6B is a block diagram illustrating an example embodiment of rule data tables and hierarchy data tables.

FIG. 7 illustrates an example web-based user interface presented by a template manager.

FIG. 8 illustrates an example web-based user interface presented by a graphics manager.

FIGS. 9-14 illustrate an example web-based user interface presented by a record manager.

FIGS. 15-17 illustrate an example web-based user interface presented by an output manager.

FIG. 18 illustrates example labels produced at an output location by a label management system in accordance with the invention.

### DETAILED DESCRIPTION

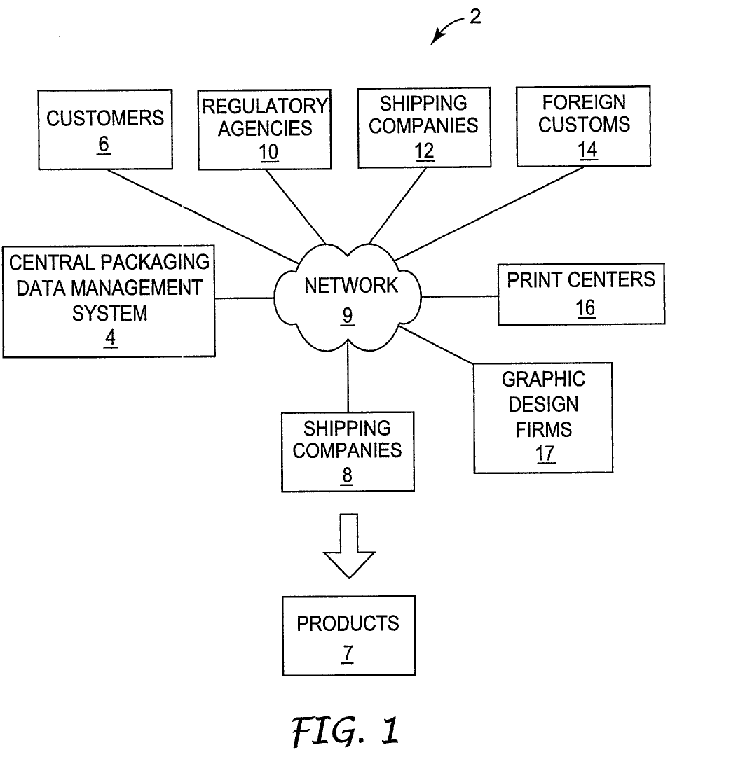

FIG. 1 is a block diagram illustrating a system 2 in which a central packaging data in which customers 6 communicate with (CPD) management system 4 to easily manage packaging data, and assemble the packaging data for application to products 7 by manufacturing facilities 8. More specifically, authorized users of customers 6 interact with CPD management system 4 via network 9 to develop and manage the packaging labels or other printed material for manufactured products. Remote manufacturing facilities 8, print centers 16 or other output locations interact with CPD management system 4 via network 9 to retrieve packaging data for customer approved labels when packaging manufactured products.

CPD management system 4 includes one or more data servers for hosting the packaging data for customers 6. Examples of such data include packaging templates, graphics, statements of compliance with regulations, translations, lists of ingredients, warnings, and other packaging data. CPD management system 4 securely organizes the data to ensure that the data for a given one of customers 6 is not accessible by any other customers 6.

By interacting with CPD management system 4, customers 6 and can easily generate packaging materials in conformance with requirements from a variety of diverse entities, including regulator agencies 10, shipping companies 12, and foreign customs 14. In other words, CPD management system 4 provides a centralized intelligent system for ensuring that labels or other packaging materials associated with products 6 complies with the specific requirements set forth by regulator agencies 10, shipping companies 12, and foreign customs 14.

CPD management system 4 includes a variety of features for application of business rules and other constraints to automate the generation and validation of packaging materials in view of the requirements. For example, as described in detail below, CPD management system 4 provides interfaces for the definition and management of rules, relationships, regulations, and other constraints to control the creation and assembly of packaging material. A host or other service provider associated with CPD management system 4 may provide a base set of rules to customers 6. In addition, customers 6 may interact with the interfaces to easily augment the rule set provided by the service provider.

Furthermore, CPD management system 4 provides a template manager that allows customers 6 to easily select packaging templates for quickly assembling packaging data based on current requirements. CPD management system 4 further includes a packaging rules engine to validate the content of any assembled labels and other packaging material in view of the requirements. In this manner, CPD management system 4 provides an intelligent packaging data warehouse with which customers 6 interact for creation, validation, and distribution of packaging data for label and other packaging materials associated with products 6.

Customers 6 may include any organization that manages packaging data for manufactured products generally. In this manner, CPD management system 4 may support customers 6 of all sizes ranging from sole proprietorships to large corporations. For example, customers 6 may include small businesses that outsource packaging to print centers 16, and large businesses, such as Wal-Mart Stores, Incorporated, Best Buy Company, Inc., Intel, Dell Computer Corporation, and the like, that have complex manufacturing facilities 8. Examples of shipping companies 10 include Federal Express, United Parcel Service, Airborne Express, and the like. Examples of regulatory agencies 10 include the Food and Drug Administration (FDA), the Environmental Protection Agency (EPA), and the like.

CPD management system 4 allows customers 6 to define and approve labels including controlling all aspects and features of the printed label including size, layout, graphics, format, warning messages, and the like, as well as the output mediums and print devices on which the labels are printed. In this manner, CPD management system 4 allows the customer to better control the layout and appearance of labels being presented to market by manufacturing facilities 6, print centers 16, or other output location. In particular, CPD management system 4 ensures that customers 6 can easily and securely communicate their packaging data to their corresponding manufacturing facilities 6 or other output locations. Consequently, CPD management system 4 ensures that, for a given customer 6, different output locations print identical labels and other packaging material for manufactured products 7. In addition, customers 6 may use CPD management system 4 to dynamically control packaging materials used during the manufacturing process.

CPD management system 4 can be used with any labeling device or system and can be used to print labels or other media, or can be used to print directly on packaging material such as folding cartons, boxes, flexible films or the like. Similarly, the packaging data, as defined herein, may be used for a variety of packaging purposes including, for example, to program radio frequency identification (RFID) tag fixed to products at the time of manufacturing. As examples, the RFID tag may be programmed with a lot code, a date of manufacture, a serial number, a UPC code or other packaging data.

Each of customers 6, regulatory agencies 10, shippers 12, and foreign customs 14 may have one or more users that remotely interacts with CPD management system 4 via network 9 to develop and manage the packaging labels or other printed material for manufactured products. A user can be any authorized individual, such as a packaging engineer within a business unit, a plant operator within a manufacturing facility 8, an agent within a regulatory agency 10 or a foreign customers 14, a service representative within a shipping company 12, a graphic designer within graphic design firm 17, or a customer service representative within print center 16, and may be geographically distributed. By interacting with CPD management system 4, as described below, users 4 can create, update, and archive packaging data, as well as generate labels for manufactured products.

A graphic designer within a business unit of a corporate customer 6 or graphic design firm 17 can create custom graphics displaying, for example, corporate trademarks for use on labels. A packaging engineer may use CPD management system 4 to create packaging templates and define labeling strategies for various “packaging levels” of a product. As referred to herein, packaging levels describe the packaging process that a product undergoes from the time the product comes off the manufacturing line to shipment. Designating a label as packaging level 1 may, for example, indicate that the label is to be placed directly on the product itself. Designating the label as packaging level 3 may indicate that the label is to be placed on a carton holding 10 individual products. Designating the label as packaging level 6 may indicate that the label is to be placed on a case packed with 12 cartons. Finally, designating the template as packaging level 8 may indicate that the label is to be placed on a crate shipped with 200 cases. A plant operator within manufacturing facility 6A may interact with CPD management system 4 to retrieve packaging data and generate appropriate labels for a given product based on the packaging level. In addition, a service representative within print center 16 may carry out high-volume print runs of labels based on packaging data retrieved from CPD management system 4.

Each user typically interacts with a computing device suitable for communication and interaction with CPD management system 4 via network 9. For example, a user may use a workstation, personal computer, laptop computer, or even a personal digital assistant (PDA) such as a Palm™ organizer from Palm Inc. of Santa Clara, Calif. or Windows CE device.

The communication device executes communication software, typically a web browser such as Internet Explorer™ from Microsoft Corporation of Redmond, Wash., in order to communicate with CPD management system 4. Network 9 represents any communication link suitable for communicating data, such as a wide-area network, local area network, or a global computer network like the World Wide Web.

By interacting with CPD management system 4, customers 6 can securely develop a centralized label management process for their respective manufacturing facilities 8 and products 5 and, therefore, eliminate redundancies and inefficiencies inherent to a decentralized process. Users of a given company may, for example, develop and manage standardized graphics, allowing the company to provide more consistency and accuracy in the appearance of labeling entering distribution channels and customer markets. As described below, customers 6 can control and manage labels used for packaging, including the various sizes, layouts, formats, as well as the output mediums on which the labels are printed. This allows customers 6 to better control the packaging information being presented to market on shipped on or with their products 5. In particular, for a given customer, multiple output locations, such as manufacturing facilities 6 and print center 16, and multiple output devices within a location, receive the same packaging data and, therefore, can print identical labels and other print material for packages and manufactured products. Accordingly, by providing access to CPD management system 4, label changes can be propagated universally and instantly throughout an organization.

One advantage of CPD management system 4 is the ability to support relocation of products from one manufacturing facility 6 to another. In other words, because CPD management system 4 centrally manages packaging data, a customer 6, for example, can relocate products from one manufacturing facility to another without needing to transfer labeling information, such as one or more digital files necessary to render a label. This process may be difficult with conventional desktop graphic design and label creation tools that typically execute on standalone workstations.

Another feature of CPD management system 4, as described below, is incorporation of revision control modules for developing and maintaining packaging data. CPD management system 4, for example, includes revision control modules for controlling packaging data through all stages of the process including developing the label, approving the label for use by manufacturing facilities 6 and print center 16, and archiving and time stamping the label for subsequent verification. CPD management system 4 supports, for example, check-in and check-out procedures for controlling access to packaging templates, graphics, and packaging data generally. Furthermore, these features of CPD management system 4 may be useful in tracking changes to labels and providing revision histories and other modification information.

CPD management system 4 support and facilitates “on-demand” print systems by streamlining the delivery of packaging data to such systems when needed. In other words, packaging data can be quickly distributed to print systems when a company decides to manufacture a product, thereby allowing the company to satisfy any “just-in-time” manufacturing and supply contracts and other business relationships the company may service.

CPD management system 4 may charge customers 6 fees for use of the packaging data management services. CPD management system 4 may, for example, charge customers 6 data warehouse fees based on the number of packaging records, templates and graphics, or any combination thereof, stored by each of customers 6. CPD management system 4 may also charge fees based on the number of accesses by users within customers 6. In addition, CPD management system 4 may charge subscription service fees or fees based on the number of labels printed.

Alternatively, CPD management system 4 may be offered as a value-add service coupled with other services or packaging materials. For example, services provided by CPD management system 4 may be offered to customers 6 in conjunction with the sale of packaging material, such as packaging tape.

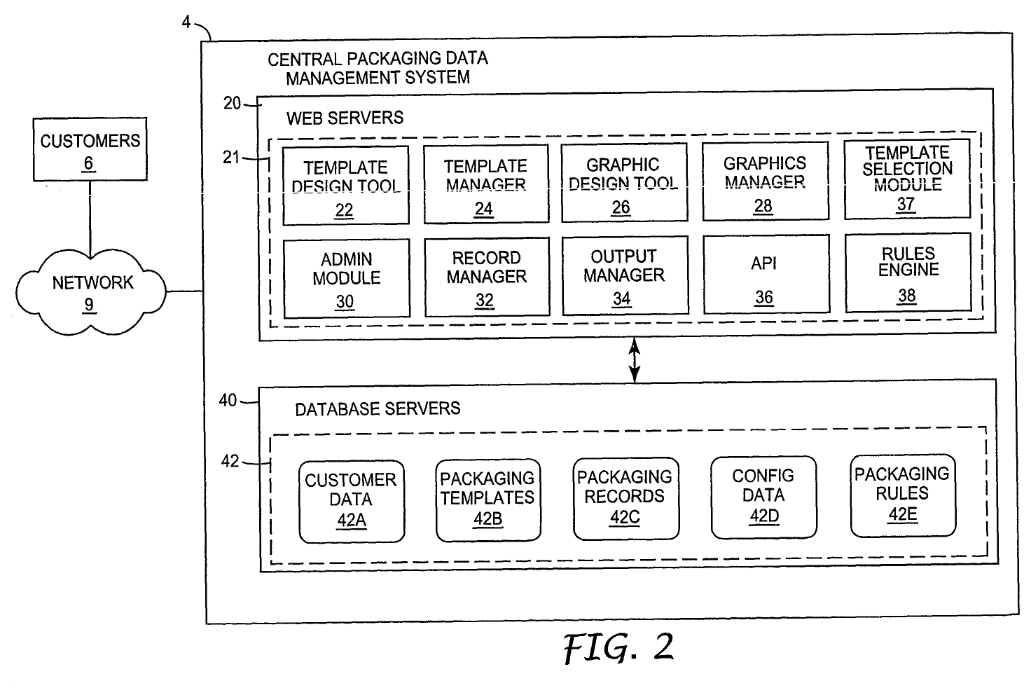

FIG. 2 is a block diagram illustrating an example embodiment of CPD management system 4 with which customers 6 interact to generate packaging materials in conformance with requirements from a variety of diverse entities, such as receiving companies, regulator agencies, shipping companies, global customs, and the like.

Web servers 20 provide an interface by which customers 6 communicate with CPD management system 4 via network 9. In one configuration, web servers 20 execute web server software, such as Internet Information Server™ from Microsoft Corporation, of Redmond, Wash. As such, web servers 20 provide an environment for interacting with customers 6 according to software modules 21, which can include Active Server Pages, web pages written in hypertext markup language (HTML) or dynamic HTML, Active X modules, Lotus scripts, Java scripts, Java Applets, Distributed Component Object Modules (DCOM) and the like.

Although illustrated as “server side” software modules executing within an operating environment provided by web server 20, software modules 21 could readily be implemented as “client-side” software modules executing on computing devices used by customers 6. Software modules 21 could, for example, be implemented as Active X modules executed by a web browser executing on the computing devices.

Software modules 21 may include a number of modules including template design tool 22, template manager 24, graphic design tool 26, graphic manager 28, administration (Admin) module 30, record manager 32, output manager 34, application programming interface (API) 36, template selection module 37 and rules engine 38. Software modules 21 interact with database server 40 to access data 42, which may include customer data 42A, templates 42B, packaging records 42C, configuration (config) data 42D, and packaging rules 42E. Data 42 may be stored in a variety of forms including data storage files, or one or more database management systems (DBMS) executing on one or more database servers. The database management systems may be a relational (RDBMS), hierarchical (HDBMS), multidimensional (MDBMS), object oriented (ODBMS or OODBMS) or object relational (ORDBMS) database management system. Data 42 could, for example, be stored within a single relational database such as SQL Server from Microsoft Corporation.

Customer data 42A include text, graphics, or other data uploaded by customers 6 for printing on labels or other packaging materials. Examples of textual data includes warnings, lists of ingredients, tracking numbers, part lists, translations, and the like. Graphics may include corporate graphics, such as trademarks, logos and other imagery, and may be stored as, for example, individual image files stored in any of a number of formats including JPEG, TIFF, GIFF, PDF and the like.

Templates 42B stores templates for creating labels and other packaging materials associated with products 7, and typically describes a layout, format and a number of fields. Packaging records 42C store packaging data generated by customers 6 from packaging templates 42B. In particular, a packaging record 42C comprises a record that associates packaging data, such as text, graphics, or other data, with fields of a packing template 42B. Configuration data 42D stores configuration data including, for example, authorized customers 6, user and corporate preferences, preferred output stock (substrates) for labels, and available printers. In addition, configuration data 42D includes data defining customers 6, manufacturing sites 6, and the various packaging levels used during the manufacturing process.

Template design tool 22 provides online design and layout functionality for creating packaging templates 42B. In other words, template design tool 22 presents a graphical user interface by which customers 6 can construct templates. During this process, customers 6 typically defines the size and layout for a template, as well as selecting a number of fields for capturing packaging data, possibly at print time. In particular, customers 6 define the templates by selecting fields from a set of uniquely identified fields. If a particular field type is not available, customers 6 may create the desired field type for use within the current and future templates. Although illustrated and described as an online, web-based template design tool, template design tool 22 may comprise a conventional label design software, such as CodeSoft™ and LabelView™ from Teklynx™, and may run on independent computing devices.

Upon creating a packaging template, customers 6 interacts with template manager 24 to “check-in” the template into CPD management system 4. During this process, template manager 24 parses the data generated by template designer 22, typically a text file with embedded codes defining a number of fields, and stores the parsed data within templates 42B. During the check-in process, the user provides all information necessary for categorizing the template including, for example, a name for the packaging template, appropriate customers 6 that may use the template, markets for which the label may be applicable, a “trustee” for the template, and the corresponding packaging level(s) for which the template applies. After describing the template, the user uploads the file produced by template design tool 22 to CPD management system 4, which stores the file in templates 42B.

Furthermore, customers 6 may interact with template manager 24 to hierarchically organize packaging templates 42B. In other words, template manager 24 allows customers 6 to define and maintain one or more hierarchical relationships for organizing packaging templates 42B. Each of customers 6 may define respective hierarchies for organizing their respective packaging templates, and may customize the hierarchies based on their needs.

A hierarchy may comprise a number of levels, and each level may comprise a number of nodes that correspond to various packaging constraints and other criteria. For example, hierarchies may be defined for criteria such as product lines, industries, countries of origin, countries of destination, selected shipping companies, recipients, and the like. Customers 6 “register” newly created templates by directing template manager 24 to associate each of the templates with a respective node of one of the hierarchies. As described in more detail below, record manager 32 provides an interface with which customers 6 can traverse the hierarchies to easily select appropriate packaging template based on current requirements.

Graphic design tool 26 provides a web-based design tool for creating graphics such as corporate trademarks, logos, and the like. In other words, graphic design tool 26 presents a graphical user interface by which customers 6 can construct images. Alternatively, uses 18 may use a conventional graphic design software, such as Adobe Photoshop™ from Adobe System Incorporated or Corel Draw™ from Corel, Inc.

After creating graphics for corporate labels, a customer 6 interacts with graphic manager 28 to check-in the graphics into CPD management system 4. During the process, the customers 6 typically uploads the graphic file, such as a JPEG, GIF, TIFF or PDF file, to CPD management system 4, which stores the file in graphics data store 42A.

Administration (admin) module 30 present an interface by which authorized users, such as system administrators, configure CPD management system 4. A system administrator may, for example, manage accounts for customers 6 including setting access privileges, and define a number of corporate and user preferences. Examples of corporate preferences include preferred language translations, signature lines, suggested label stock. Examples of user preferences include authorized printers for each user, as well user access rights to modules 21. Admin module 30 allows the system administrator to define access rights for customers 6 to control the access to the various software modules 21. In this manner, not all users can access all of the software modules 21. For example, a graphic designer may have access rights to graphic designer software module 26 and graphics manager 28, while a plant operator may only have access rights for the output manager 34.

In addition, a system administrator can interact with admin module 30 the administrator can define logical categories and hierarchies for characterizing and describing labels used for packaging and manufacturing. The system administrator may define, for example, categories such as markets, business units and a hierarchy of packaging levels, such as levels one through eight. In addition, the system administrator may define a number of label fields supported by CPD management system 4.

Record manager 32 allows customers 6 to define labels or other printed materials associated with manufactured products, based on packaging templates 42B, customer data 42A and config data 42D. In other words, customers 6 interact with record manager 32 to create new package records 42C for packaging materials based on packaging templates 42B, and populate the fields of the templates with text, graphics or other data.

To create a package record, a customer 6 initially directs record manager 32 to select a packaging template 42. To facilitate this process, record manager 32 provides an interface with which customers 6 can traverse the hierarchies to easily select an appropriate packaging template based on current shipping requirements. In particular, record manager 32 incorporates decision tree logic to filter packaging templates based on a hierarchy selected a customer 6. As the customer 6 traverses a hierarchy, record manager 32 selectively presents the set of packaging templates registered against the currently selected node of the tree. In this manner, record manager 32 allows customers 6 to drill down into storage packaging data to select appropriate templates for assembling and outputting packaging material. For example, record manager 32 may request information from a customer 6, such as a product line, a country of origin, a destination country, an industry, a shipping company, a recipient, and the like. Record manager 32 presents a set of packaging templates 42B that match the supplied criteria.

Upon selecting a template, the customer 6 interacts with record manager 32 to populate the fields of the template with text, graphics or other data, and to store the populated template as a new package record 42C. In particular, record manager 23 provides an interface by which the customer 6 can set various characteristics and properties for the defined fields for the template. A user may, for example, enable “dynamic scaling” for a text or graphic element field, causing CPD management system 4 to dynamically select a font size for corresponding text or dynamically scale the graphic element, so that the text or graphic element can be fully displayed within the label field.

During the process of assembling a packaging template 42B into a packaging record 42C, record manager 32 engages rules engine 38 to validate the content of the packaging record. Rules engine 38 validates the content of the record in view of packaging rules 42E, which may represent particular constraints, such as regulations from regulatory agencies, requirements for particular shipping companies or recipients, and the like. Packaging rules 42E may also be used to provide informational text, such as comments or suggestions, to customers 6 during the process of assembling packaging records 42C. For example, packaging rules 42E may be created to present “Based on your selected destination country of Germany and the selected industry of Health Care, be sure to include a Group Code and a Recycle Number within your packaging record.”

To control the application of packaging rules 42E, each of the packaging rules may be associated with one or more fields of packaging templates 42B. As described above, packaging templates 42B are formed from a set of uniquely identified fields. Customer 6 interacts with record manager 32 to define packaging rules 42E for validating package records 42C, and to relate the rules to the one or more fields. When invoked by record manager 32 during the process of assembling a new package record 42C, rules engine 38 selectively applies packaging rules 42E to the fields of the new package record. More specifically, rules engine 38 selects and applies packaging rules 42E to the new package record based on the unique identifiers of the fields of the new package record.

As with packaging templates 42B, packaging rules 42E may be organized hierarchically. Records manager 32 provides an interface by which customers 6 define and maintain one or more hierarchical relationships for organizing packaging rules 42E. Each of customers 6 may define respective hierarchies for organizing their respective packaging templates, and may customize the hierarchies based on their needs. As with packaging templates 42B, customers 6 may define hierarchies that comprise a number of levels having nodes corresponding to various packaging constraints and other criteria. Customers 6 need not necessarily create new hierarchies, but may use common hierarchies to organize both packaging templates 42B and packing rules 42F. Customers 6 “register” newly created packaging rules 42E by directing record manager 24 to associate each of the rules with a respective node of one of the hierarchies. A service provider or other host for CPD management system 4 may provide a set of base rules. Customers 6 may augment these rules with customer-specific rules for validating packaging records 42C when assembled.

Record manager 32 integrates formal control modules and procedures to manage the process of developing and maintaining packaging records 42C. Record manager 32, for example, includes revision control modules for controlling the development of Packaging records 42C from creation to approval and archival. Record manager 32 supports, for example, check-in and check-out mechanisms for controlling access to packaging records and tracks modifications to the records to provide revision histories and other modification information. Each packaging record has a corresponding status, such as draft, pending, approved, archived, obsolete and superceded.

Upon validation, a customer 6 changes a status for a packaging record from “draft” to “approved.” In response, record manager 34 generates an electronic image of the label, such as a PDF (portable document format) output, timestamps the image and archives the image. A version of the image may be stored as a low resolution “thumbnail” to facilitate ready identification by users without the need to retrieve the entire high-resolution image. Record manager 32 associates data from the corresponding packaging record with the archived label image to allow for indexing and quick retrieval. In this manner, CPD management system 4 provides an intelligent packaging data warehouse with which customers 6 interact for creation, validation, and distribution of packaging data for label and other packaging materials associated with products 6.

Output manager 34 controls all aspects of printing. Once a customers 6 has created a template and entered the template into CPD management system 4, created a corresponding record for the template and populated the fields of the template, output manager 34 marks the packaging record available for printing at manufacturing facilities 6 or print center 16. Only records having an approved status are “published” to manufacturing facilities 6, i.e., are available to customers 6 via the output manager 34. This gives customers 6 the ability to manage data, add new labels, update labels without concern about the possibility that one of manufacturing sites 6 may prematurely use an unapproved label. As described below, run-time fields can be added to the template during design, which causes output manager 34 to prompt for the information at the time of print. Examples of run-time information include batch code, lot code, manufacture date, serial numbers and the like. In one embodiment, label management system stores the run-time data as labels or other materials are printed for tracking and tracing purposes.

Application programming interface (API) 36 provides the ability to establish direct connections with external computing devices. API 36 may be used to allow such devices to automatically control CPD management system 4, or for automatically retrieving data from such devices. For example, a front-end module, such as a script or command line interface provided by the remote computing device, for example, may communicate with API 36 directly, bypassing the interfaces presented by other software modules 21. In this manner, the front-end module can automatically interact with CPD management system 4 and control output. As a result, API 36 can be useful when connecting to internal corporate systems to incorporate, for example, product information. In addition, API 36 may be used at manufacturing time to automatically provide run-time information for labels and other printed materials.

API 36 also allows CPD management system 4 to directly access external data sources, such as data sources within customers 6, regulatory agencies 10, shipping companies 12, foreign customs 14, or the like. Record manager 32 may, for example, invoke API for retrieving packaging data directly from a data source maintained by a customer 6.

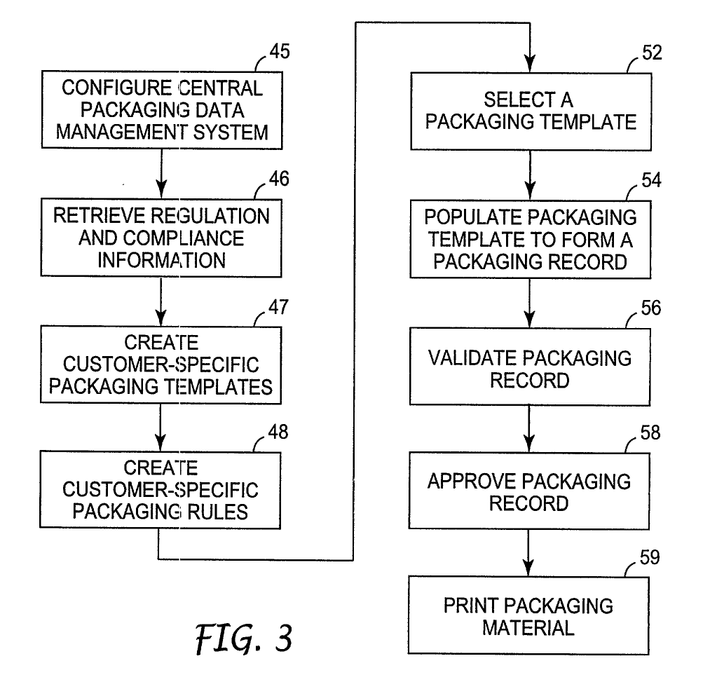

FIG. 3 is a flowchart that provides a high-level overview of example operation of CPD management system 4. Initially, a system administrator of a service provider or other host of CPD management system 4 interacts with admin module 30 to configure the CPD management system (45). For example, the authorized user may add new customers 6, setup user accounts, and define preferences, access rights and the like. In addition, the system administrator may create base sets of packaging templates 42B, packaging rules 42E, as well as hierarchies for organizing the templates and rules. During this process, CPD management system 4 may automatically access and retrieve regulation and compliance information from external data sources, such as regulatory agencies 10, shipping companies 12, and foreign customs 14 (46). CPD management system 4 updates packaging rules 42E based on the gathered information, thereby ensuring compliance with the regulations.

Next, an authorized user of a customer 6 may interact with template design tool 22 and template manager 24 to develop additional customer-specific packaging templates, and register the new templates against the defined hierarchies (47). Similarly, the user may interact with record manager to develop and register additional customer-specific packaging rules for validating their packing records 42C (48). The user may also interact with graphic design tool 26 and graphic manager 28 to develop and manage corporate approved graphics for printing on the labels or other packing materials (50).

Next, the user interacts with record manager 32 to create new packaging records 42C by first selecting one of packaging templates 42B. As described above, record manager may invoke decision-tree logic to filter and present a subset of packaging templates 42B based on the hierarchical arrangement of the templates (52).

Upon selecting a template, the user assembles a new packaging record by populating the various fields of the template with text, graphics or other packaging data (54). To populate a given field, record manager 32 may receive input data from the user, retrieve data from database server 40, retrieve data from one or more external databases via API 36, and the like. Once populated, or during the population process, record manager 32 invokes rules engine 38 to validate the content of each field by application of packaging rules 42E (56). Once validated by record manager 32, and approved by the user, record manger 32 marks the packaging record as “Approved,” thereby allowing access by manufacturing facilities 6 (58). Remote manufacturing facilities 6, print centers 16 or other output locations interact with output manager 34 to securely retrieve packaging records 42C for customers 6, and print approved labels or other materials for manufactured products 7 (59).

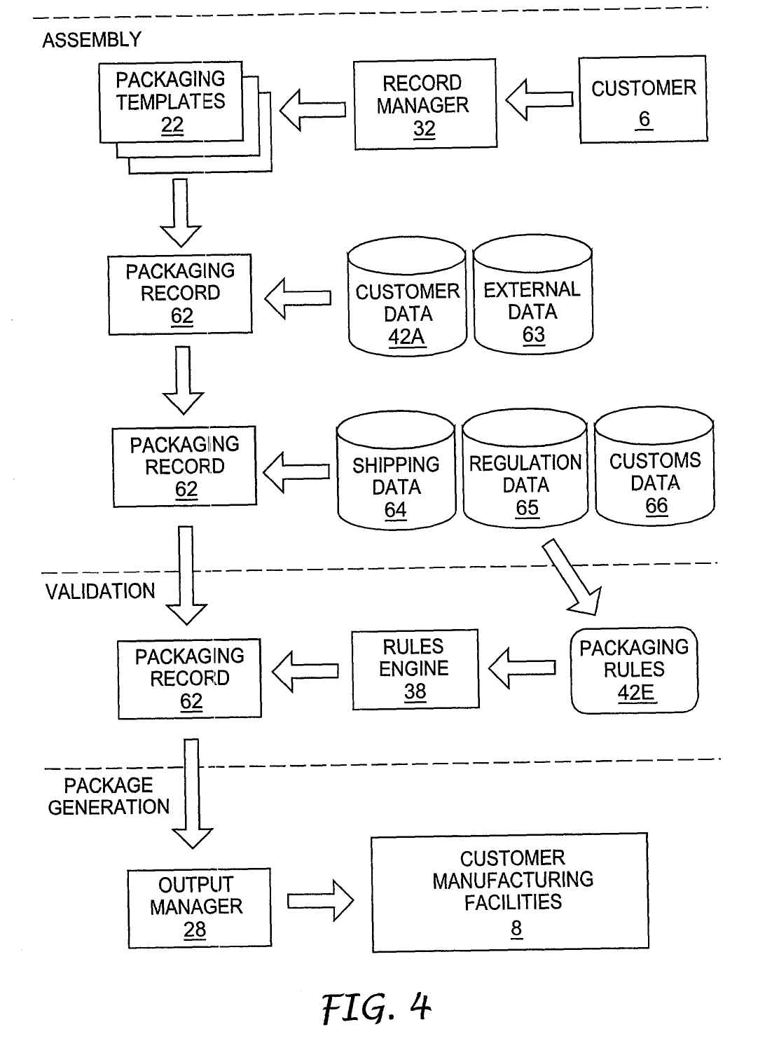

FIG. 4 is a block diagram proving another high-level overview of the operation of CPD management system 4. As illustrated, an authorized user of a customer 6 interacts with record manager 32 to select a template from packaging templates 42B. As described above, record manager 32 may invoke decision-tree logic to filter and present a subset of packaging templates 42B based on the hierarchical arrangement of the templates.

Upon selecting a template, the user assembles a new packaging record 62 by populating the various fields of the template with text, graphics or other packaging data. To populate a given field, record manager 32 may retrieve input from customer data 42A that is warehoused by CPD management system 4. In addition, record manager 32 may retrieve customer data from an external data source, such as a customer database. In particular, each field within a packaging template may be mapped to an external data source for directly retrieving data. To facilitate data transfer, record manager 32 may support data sources that are compliant with the eXtensible Markup Language (XML) or other data description language.

In addition, record manager 32 may automatically access and retrieve regulation and compliance information from external data sources, such as shipping data 64, regulation data 65, and customs data 66. Record manager 32 may incorporate some of this data directly within packaging record 62 as content to be printed on the packaging material. For example, shipping data 64 may include instructions from a selected shipping company to be printed on a label or other packaging material. Furthermore, record manager 32 may update packaging rules 42E based on the gathered information. Rules engine 38 applies the packaging rues to the contents of the newly created packaging record 62 to validate the content in view of the information gathered from shipping data 64, regulation data 65, customs data 66, or other external data source, as well as customer-specific packaging rules, or rules created by a service provider for CPD management system 4. Once validated, a remote manufacturing facility 6 or other output location interacts with output manager 34 to retrieve packaging record 62 and print a label or other packaging material.

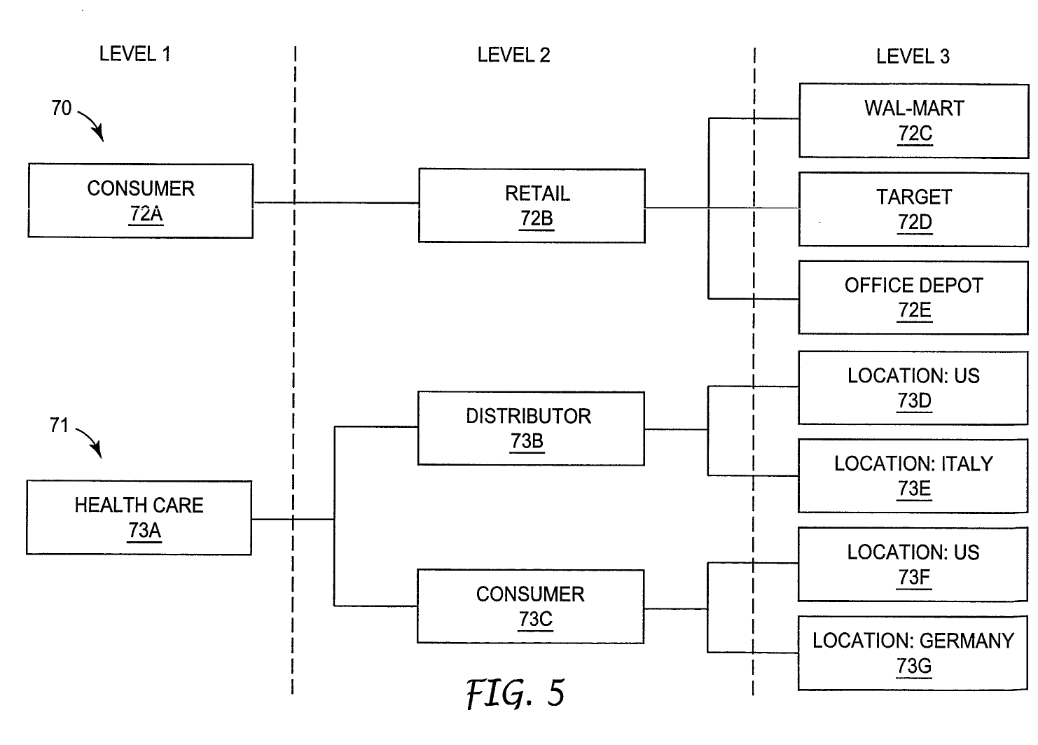

FIG. 5 illustrates example hierarchies 70, 71 for organizing packaging templates 22 and business rules 28 within CPD management system 4. In this example, each example hierarchy 70, 71 comprises a three-level hierarchy having a plurality of nodes. Packaging templates and business rules may be registered against any of the nodes, thereby organizing the templates and business rules in a hierarchical fashion for ease of use.

In particular, hierarchy 70 defines a first level having a Consumer node 72A, a second level having a Retail node 72B, and a third level having a Wal-Mart node 72C and a Target node 72D. Hierarchy 70 may, for example, be useful in organizing packaging templates relating to shipping of consumer products to various retail destinations, i.e., retail stores of Wal-Mart Stores, Incorporated, and Target Brands, Incorporated.

Hierarchy 71 defines a first level having a Health Care node 73A, a second level having a Distributor node 73B and a Consumer node 73C. Hierarchy 71 further comprises a third level having nodes 73D-73G for various shipping destinations. Hierarchy 71 may be useful in organizing packaging templates relating to shipping products to various locations within the health care industry. For example, packaging templates and business rules associated with the various nodes of hierarchy 71 may provide regulatory information necessary for shipping health care related products, and may vary based on the destination.

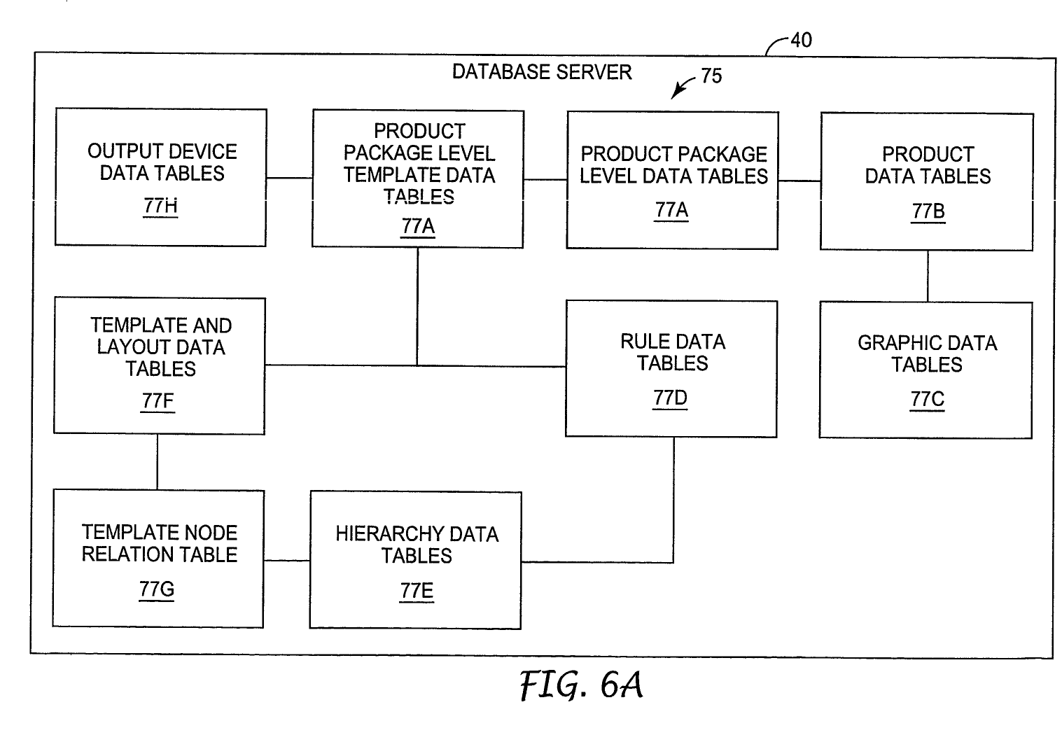

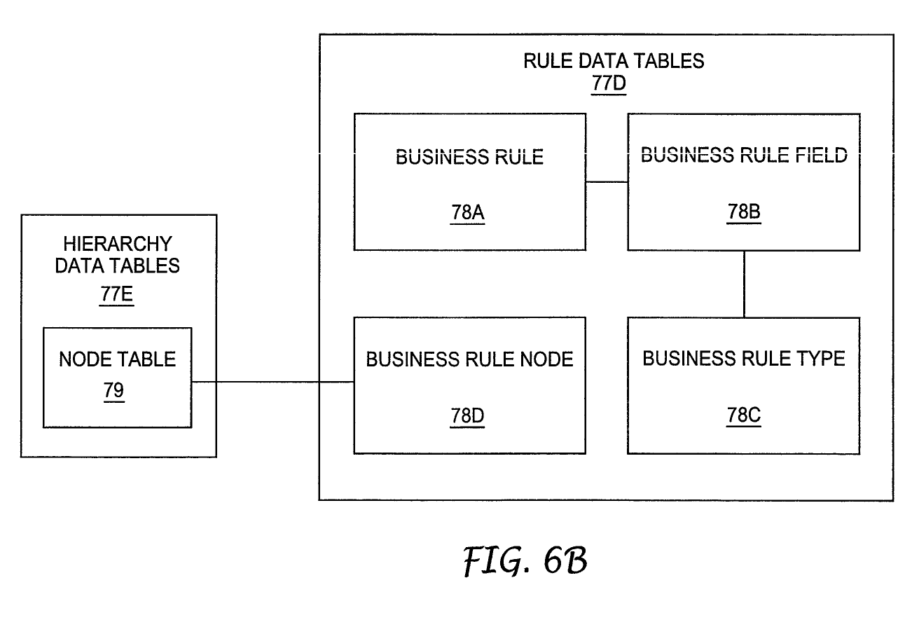

FIG. 6A is a block diagram illustrating an example schema 75 for storing data within database server 40. In this example, schema 75 represents a schema for a relational database, such as SQL Server from Microsoft Corporation. Schema 75 includes a number of related tables 77A-77H. Each table includes one or more columns (not shown) for storing data.

Consumer data 42A may be stored in product data tables 77B and graphic data tables 77C. Product data tables 77B may include a number of related tables for storing information such as product identifiers, versions, product names, countries of origin, product trademarks, product statements, translations, manufacturing addresses, and the like. Graphic data tables 77C may include a number of related tables for storing graphic identifiers, types and descriptions of graphics, and the like.

Template and layout data tables 77F stores packaging templates 42B, and may include a number of related tables for storing a template identifier, template field identifiers, field types, table owners, and the like.

Rule data tables 77D stores data describing packaging rules 42E applied by rules engine 38. For example, rule data tables 77D stores rule identifiers, field identifiers to associate the rules with particular field identifiers of template and layout data tables 77F, rule types, data defining the requirements or the rules, and the like. The requirements for a particular rule may be stored in a variety of forms, such as Boolean logic for required packaging content, an XML schema defining syntax and content for particular field, and the like.

The following pseudocode illustrates an example set of business rules, and information for presenting to the user, stored in XML form:

<BusinessRuleList>

<BusinessRules>

<BusinessRule>* If selling to the Educational sector, include
“Not for resale”.</BusinessRule>
<BusinessRule>* Use of an I 2of5 barcode for this pack level
requires a 5:2 bar width ratio.</BusinessRule>
<BusinessRule>* Use of Latin American Spanish requires
validation with Mexico customs for standard
terminology.</BusinessRule>
<BusinessRule>* The product description field must be Times
New Roman to comply with corporate
guidelines.</BusinessRule>

</BusinessRules>

</BusinessRuleList>

Hierarchy data tables 77E stores data describing the various hierarchies created and maintained for organizing and filtering the packaging templates and business rules. In particular, hierarchy data tables 77E store node identifiers, descriptions of the nodes, and data for interrelating the nodes in hierarchical form, and node type, such as a template node or a business rule node. Furthermore, hierarchy data tables 77E store template identifiers to relate the nodes with packaging templates stored in template and layout data tables 77F, and business rules stored in business rule data 77D.

Product package-level template data tables 77A and product package level data tables 77B store information describing and relating packaging templates to various “packaging levels” of a product, i.e., the packaging levels of the packaging process that a product undergoes from the time the product comes off the manufacturing line to shipment. These tables may store product identifiers, version numbers, packaging level (“pack level”) identifiers, translations, printing locations for the various levels, and the like.

Output device data tables 77H store data for controlling printing devices within manufacturing facilities 8 and other output locations. For example, output device data tables 77H include tables to store device identifiers, device descriptions, printing location, and the like.

FIG. 6B is a block diagram illustrating an example embodiment of rule data tables 77D and hierarchy data tables 77E. In the illustrated embodiment, rule data tables 77D includes four tables: BusinessRule table 78A to define new rules and store a textual representation of each rule, a BusinessRuleField table 78B to associate the rules with particular field identifiers of templates, a BusinessRuleType table 78C to define different types of business rules, and a BusinessRuleNode table 78D to associate the rules with nodes of hierarchies defined within NodeTable 79 of hierarchy data tables 77E.

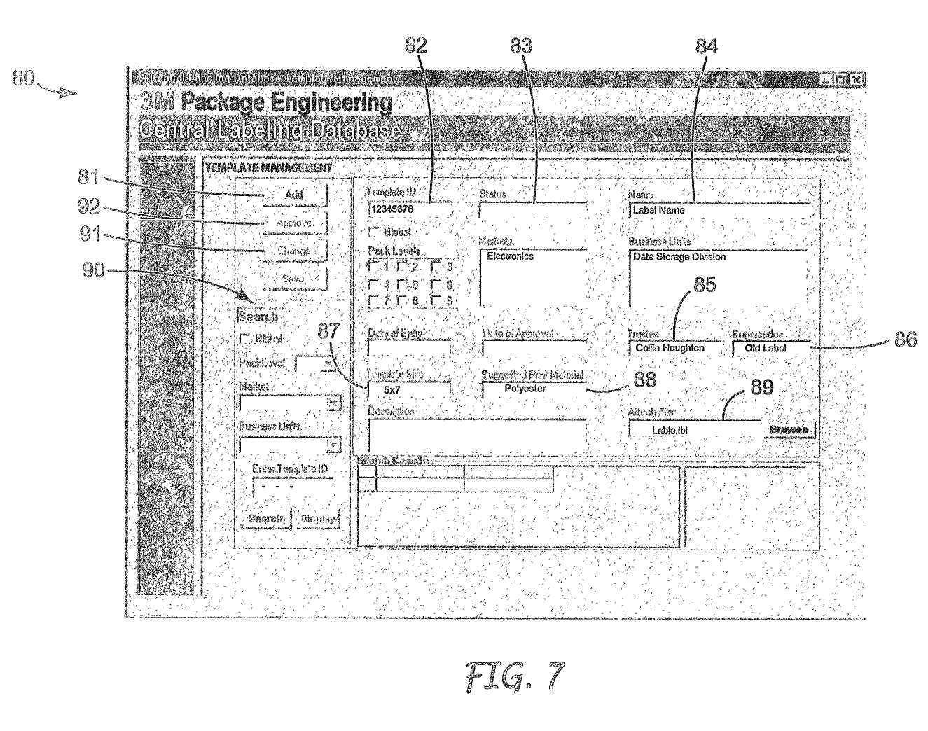

FIG. 7 illustrates an example web-based user interface 80 presented by template manager 24. An authorized user can check-in templates to CPD management system 4 by clicking on the Add button 81, at which time CPD management system 4 automatically assigns a unique template ID 82 and initializes a publication status 83 to “Draft.” At this time, the user can assign a template name 84.

Interface 80 provided by template manager 24 supports the logical categories defined by the corporation for managing templates throughout customers 6. When adding a new template, for example, the user may mark the template as global to make the template available throughout the company. Alternatively, the user may specify a packaging level, business unit and market for the template. The trustee 85 indicates the user that has authority to modify the template being checked-in, typically the user that created the template using graphic design tool 22.

Often, a template may supersede an older template, as identified by window 85. Template size 87, such as 5×7, indicates the physical size of the template when printed. All of the parameters and attributes captured by template manager 24 will be stored in CPD management system 4 and be available later to the user via other software modules 21, including record manager 32 and output manager 34. The user can suggest print material for the label within window 88. When printing the label, as described below, the output manager displays the suggested print material to aid the operator. Finally, the user can attach a template file produced by the template designer 22 by entering a filename within window 89.

Search window 90 allows the user to locate one of stored packaging template 42B instead of creating a new template. After finding a template, the user can modify the parameters and select change button 91. After finalizing the template, the user can “approve” the template by selecting the approve button 92, thereby marking the template as available for use.

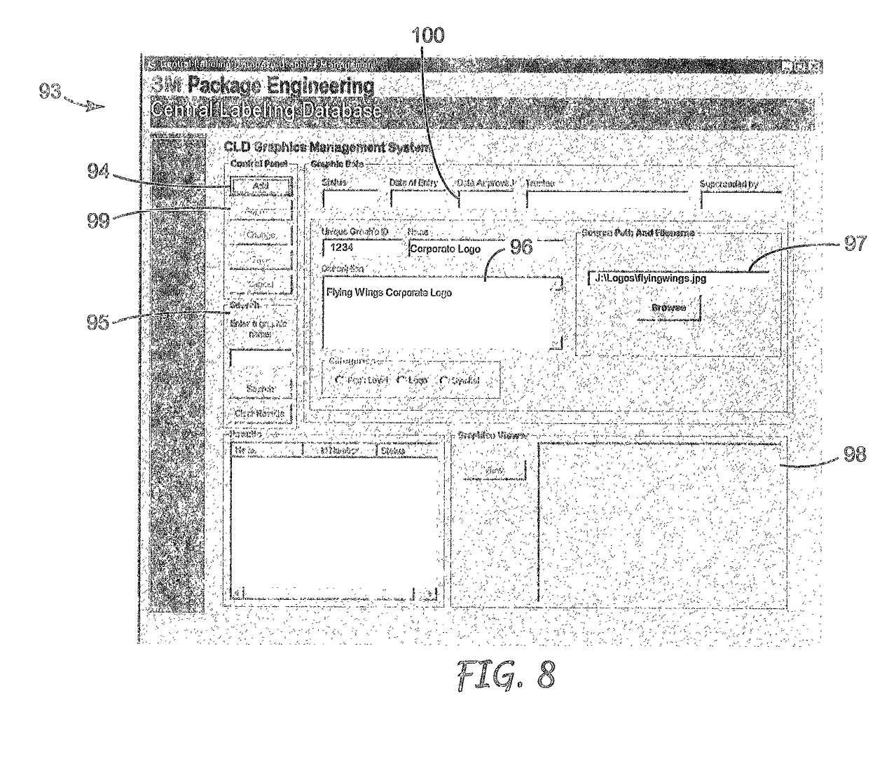

FIG. 8 illustrates an example web-based user interface 93 presented by graphics manager 28. An authorized user can check-in graphics to CPD management system 4 by clicking on the Add button 94 after completing the various fields presented by interface 93, at which time CPD management system 4 automatically assigns a unique graphic ID and initializes a status for the graphic to “Draft.” Typically, the user assigns a graphic name 95, provides a short description 96 and provides a location 97 where the graphic file is located.

After checking in the graphic, the user can modify the data describing the graphic, or update the image itself. Interface 93 provides viewer 98 by which the user can preview the image during the check-in and modification process. Upon approving the graphic, by selecting the Approve button 99, graphic manager 28 changes the status to approved and records the date approved 100.

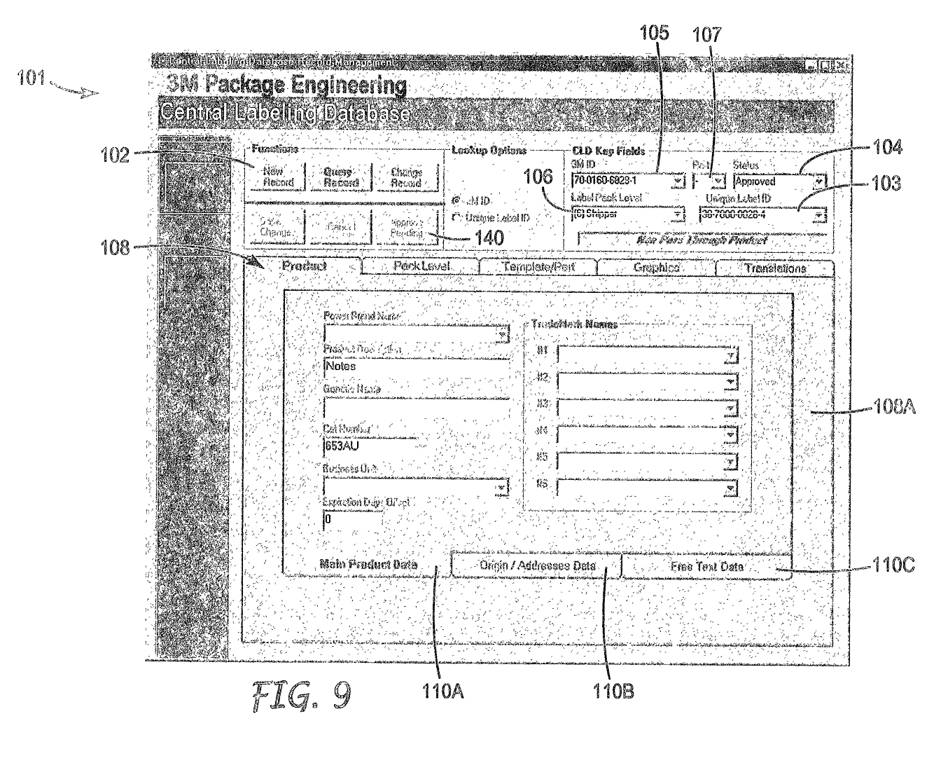

FIGS. 9-14 illustrate an example web-based user interface 101 presented by record manager 32. Generally, interface 101 allows users to define labels for use on packaging and manufactured products using on packaging templates and graphics uploaded to CPD management system 4 by template manager 22 and graphics manager 28, respectively. Referring to FIG. 6, users interact with interface 101 presented by record manager 32 to provide data for the fields of a selected template. The user may, for example, associate a field with text, graphics or other data.

To create a packaging record, a user having rights to access record manager 32 selects New Record button 102 at which time CPD management system 4 automatically assigns a unique label ID 103 and initializes a status 104 for the record to “Draft.” The unique label ID is useful for compliance with regulations, such as the regulations found in the health care and pharmaceutical industries that require a labeling change management process, for example utilizing a single, unique control number for each label.

The user may also select a pre-existing packaging record and make changes. Interface 101 offers two mechanisms for selecting a record. The user may traverse the logical categories defined for CPD management system 4 by providing, for example, a corporate label ID 105, a packaging level 106, and a corresponding manufactured part or product 107. For a given corporate ID number 102, there may be a number of records covering the various packaging levels. These records form a related family that can share common data, such as a message or warning text that must be displayed on labels for all packaging levels. The second method for finding a label is to supply the unique label ID 103.

In another embodiment, record manager 32 displays a number of graphic thumbnails from which the user selects a desired packaging template. Record manager 32 then graphically displays graphics associated with the selected packaging template and overlays the corresponding fields.

When creating a packaging record, CPD management system 4 allows the users to control when manufacturing facilities 6 use an updated label. This may be useful in heavily regulated industries where the manufacturing company may need to record the specific point where labels change, such as in the medical and pharmaceutical industries. In particular, the user can classify the record as “pass through” or as “non-pass through.” The output manager 34 uses an updated label immediately if the label is designated as “pass through.” Once a user has approved a pass through packaging record, the old record is immediately replaced and an image of the label for the old record is archived in a graphic format, such as PDF, to create a permanent record of the old label.

For non-pass through labels, output manager 34 allows the manufacturing facilities 6 to control when the updated packaging record is used in place of the superceded packaging record. This allows the manufacturing facilities 6 to print the older labels for a desired period of time, such as until the end of a batch run or the depletion of current inventory. During this process, CPD management system 4 automatically maintains a duplicate packaging record within Packaging records 42C controlled by the corporate ID number. Manufacturing facilities 6 can elect when to replace the old record with the updated one.

Interface 101 provides a number of data entry windows 108 for mapping information, such as text and graphics, to corresponding fields within the selected packaging template. In other words, data entry windows 108 present the logical elements of information that may exist on approved corporate packaging labels, and are initially defined by a system administrator or other authorized user. In one embodiment, interface 101 displays only the fields that exist on the selected template. In this embodiment, record manager 32 determines the defined fields for the corresponding packaging template and presents those fields within data entry windows 108. Data entry windows 108 may require that the input from the user match constraints defined within template manager 24 during template creation. In this manner, the template may control the number of characters and format for each field.

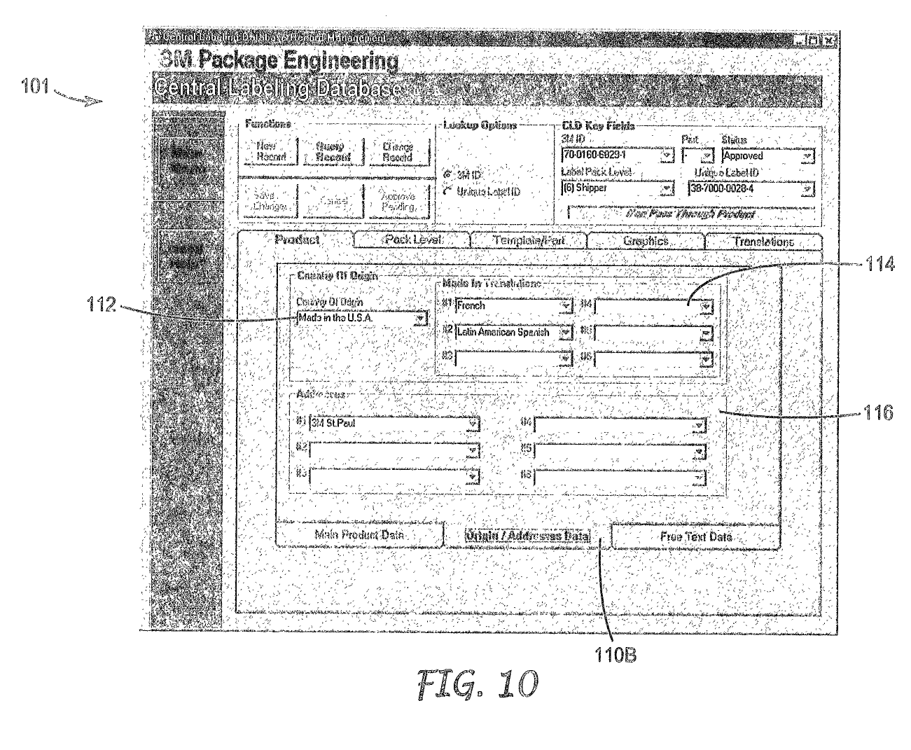

Product data entry window 108A captures product specific data for the selected packaging record and includes three windows including main product data entry window 110A, origin-address data entry window 110B and free text data entry window 110C. As illustrated in FIG. 10, origin-address data entry window 110B allows a user to specify a country of origin 112 for the product, translations 114 that are available for the label, and an address 116 of the manufacturer. Free text data allows the user to add miscellaneous messages such as “50% off” or “Buy one get one free” to a label.

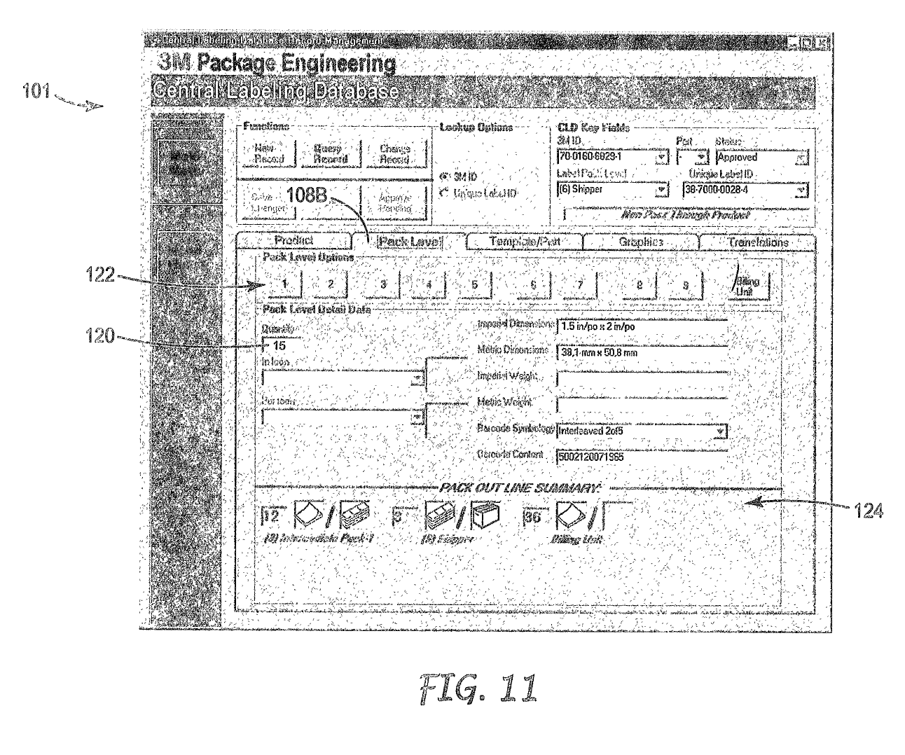

FIG. 11 illustrates packaging level data entry window 108B of user interface 101. Packaging level data entry window 1 08 B allows the user to identify the packaging levels for a manufacturing product. In particular, the user can define the quantity 120 of the product within each of packaging levels 122, and define various features, such as size and weight, at each level. In addition, the user may select graphical icons representing the components and container for each packaging level. Window 124 graphically illustrates the packaging process.

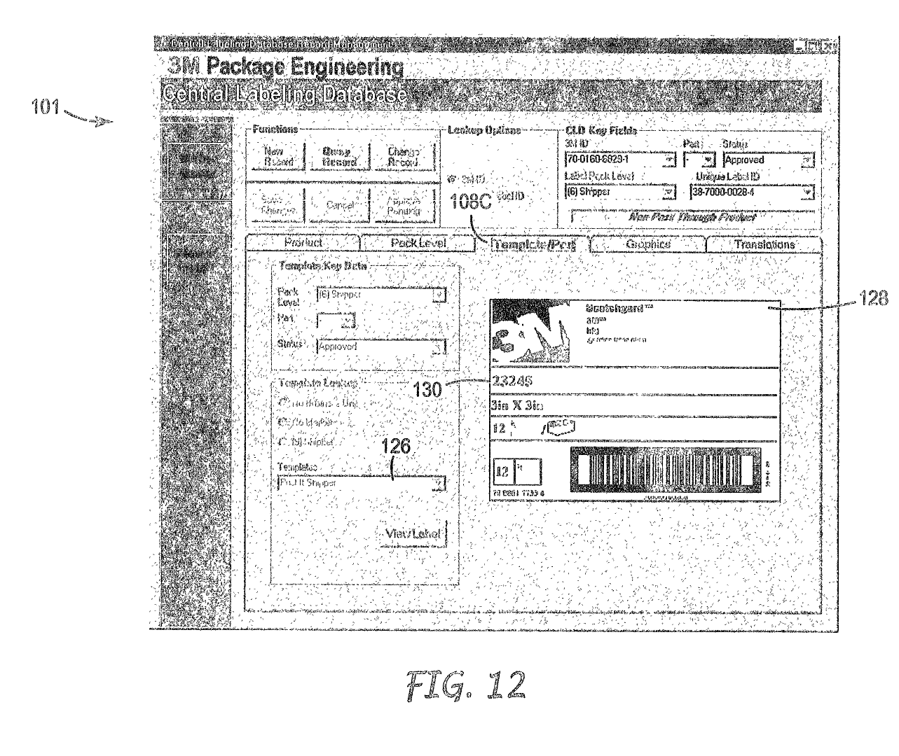

FIG. 12 illustrates template-part data entry window 108C of user interface 101. Template-part data entry window 108C allows the user to identify the corresponding template 126 for the current packaging record, and displays an image 128 that graphically illustrates the label as well as the corresponding fields 130 associated with the label.

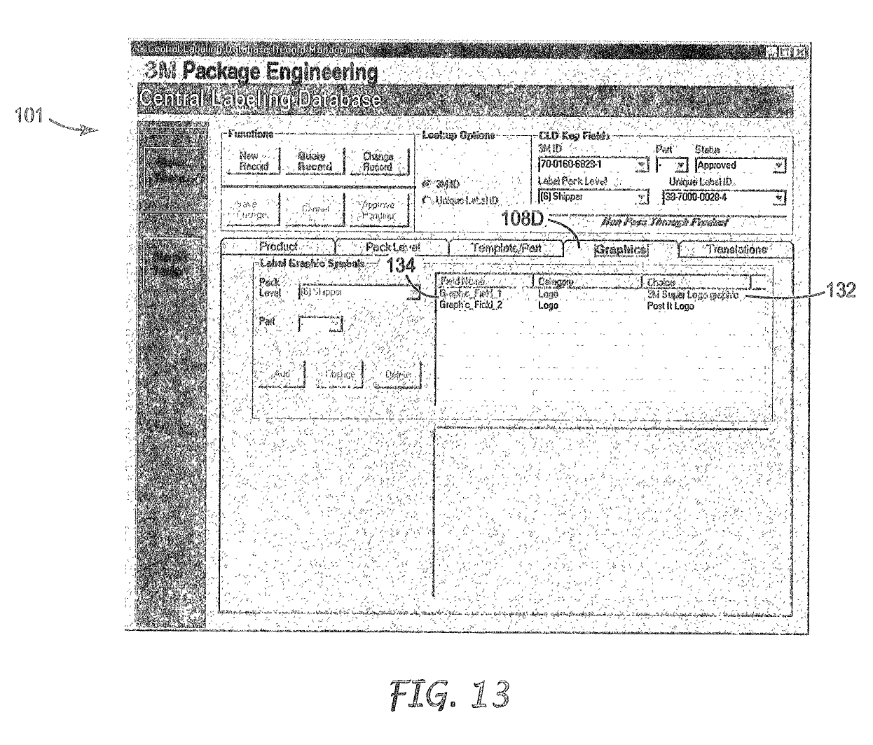

FIG. 13 illustrates graphics data entry window 108D of user interface 101 that allows the user to assign graphics 132 for the various fields 134 within the template. Graphics 132 can be can be any type of format including BITMAP, JPEG; TIFF, GIFF, EPS, and the like.

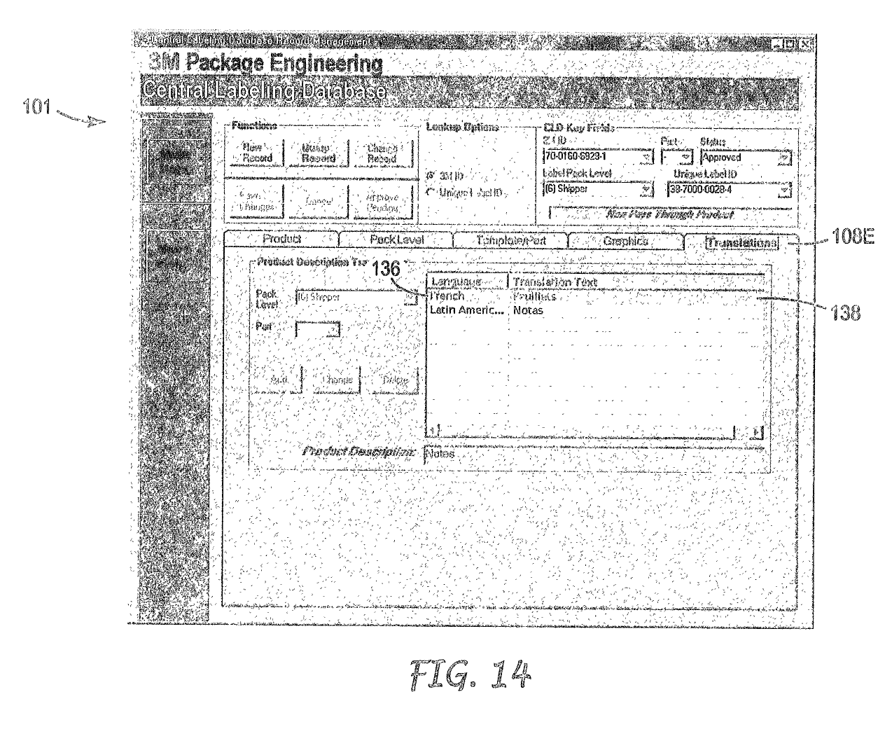

FIG. 14 illustrates translations data entry window 108E of user interface 101 that allows the user to select one or more languages 136 for the label and enter translation text 138 for one or more fields. In this manner, any text on the label can be multilingual. In one embodiment, CPD management system 4 is Unicode compliant and can readily support a wide variety of character sets.

Referring again to FIG. 9, once the user has completed the data entry process, the user can approve the label by selecting Approve button 140. Upon approval, record manager 32 generates an image, such as a PDF file, of the resultant label based on the graphics and other data associated with the fields of the selected label. In addition, record manager 32 timestamps the image and archives the image to record a visual representation of the exact label that is available for use by manufacturing facilities 6. CPD management system 4 associates data from the current record with the archived image to allow for indexing and quick retrieval.

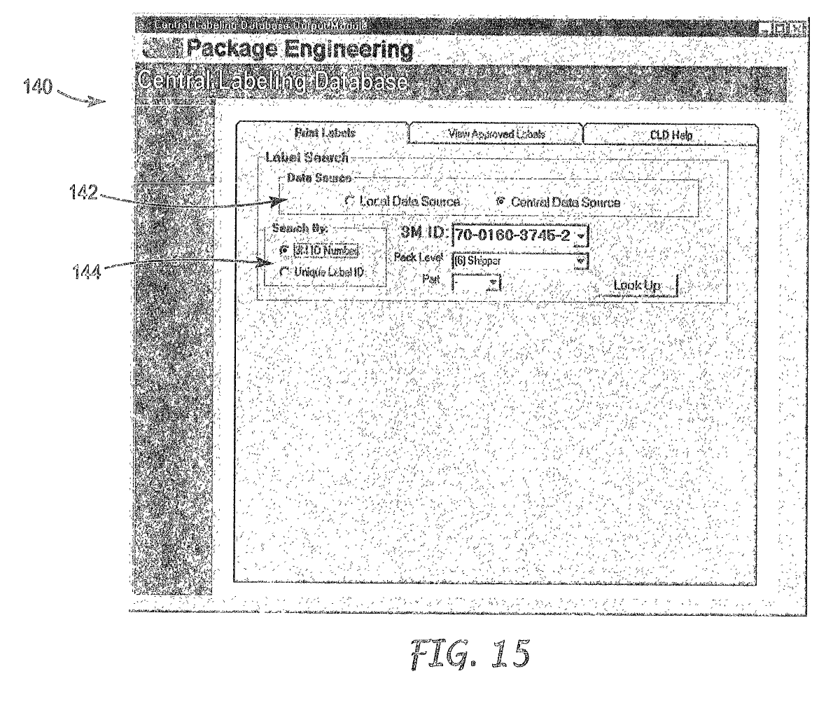

FIGS. 15-17 illustrate an example web-based user interface 140 presented by output manager 34. Generally, interface 140 controls all aspects of label printing by manufacturing facilities 6. Referring to FIG. 15, a user, such as a plant operator within one of manufacturing facilities 6, first interacts with data source selection window 142 to elect whether to retrieve packaging data from CPD management system 4 via network 9, or from a local copy of data stores 42. This option is useful to maintain manufacturing even in situation where network 9 is unavailable. Specifically, CPD management system 4 may replicate data stores 42, or portions thereof, to local servers within each manufacturing facility 6 and print center 16.

After selecting the data source, the user then selects a desired packaging record using search window 144. In particular, the user can enter a unique label ID, or a corporate ID and corresponding packaging level and part. Only Packaging records having an approved status are available to the user via output manager 34. This gives business unit 4 the ability to manage packaging data, create new labels, and update labels without worrying about the manufacturing facilities 6 prematurely using non-approved labels.

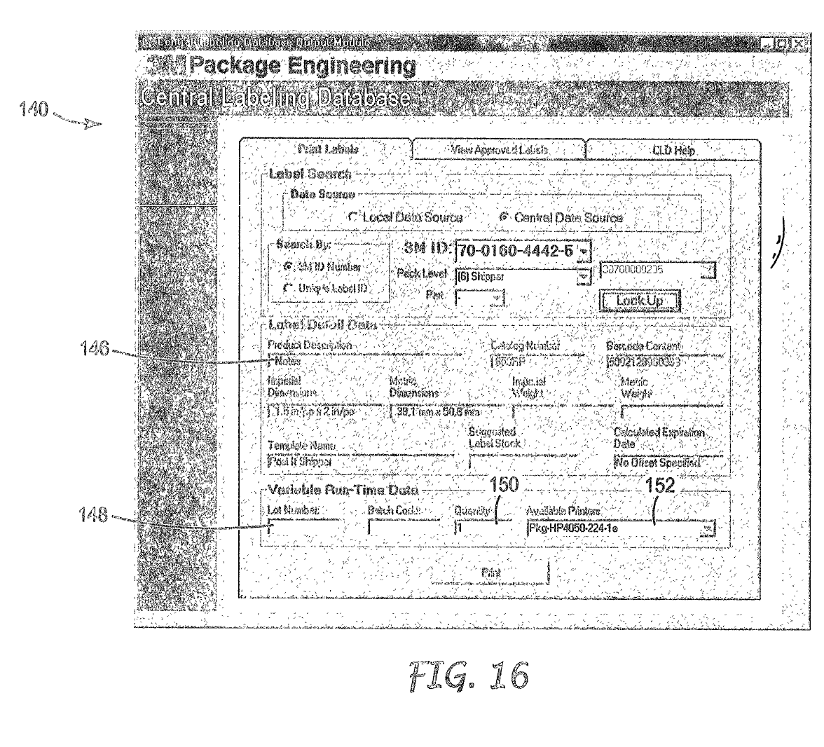

As illustrated in FIG. 16, once a label is identified, output manager 34 retrieves the detailed data for the label from Packaging records 42C and displays the data within window 146. Interface 140 displays this information in non-editable form for verification by the user. In addition, interface 140 displays any run-time fields 148, such as fields 150 and 152, for capturing data as, for example, lot number and batch code. Next, the plant operator selects a quantity 150 and an available printer 152. As described above, output manager 34 controls the list of available printers 152 based on access settings within config data 42D.

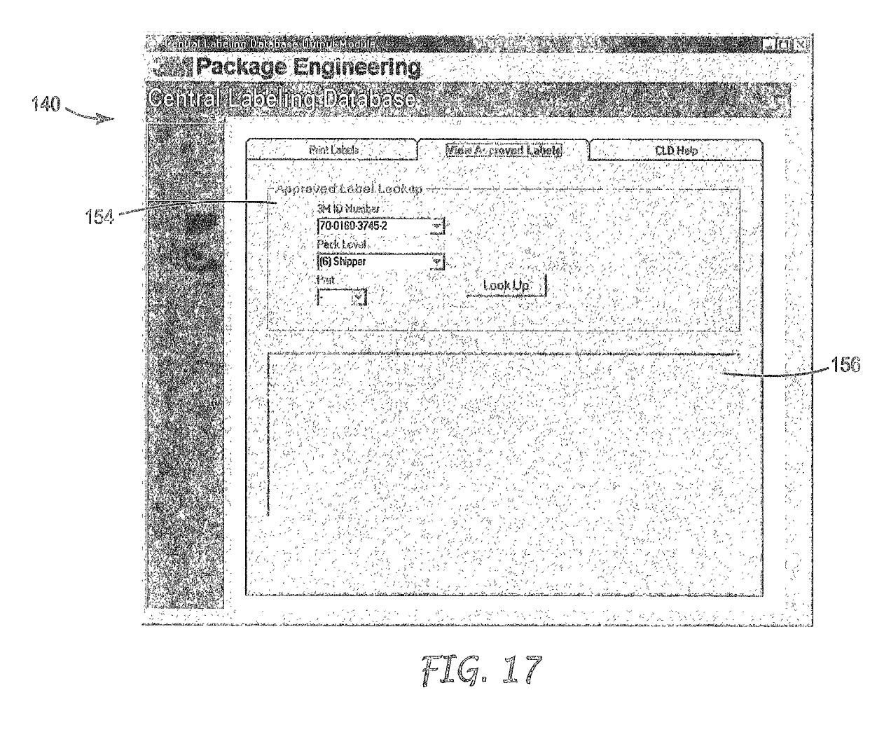

As illustrated in FIG. 17, viewing approved labels window 154 of output manager 34 provides the ability to verify a printed label or other packaging material in comparison with the approved packaging record as archived by record manager 32. More specifically, the user may typically print a single label and compare the printed label against the archived image displayed in view screen 156. Verification against the archived label is more accurate than performing a print preview, as commonly available in conventional systems. A print preview only displays the packaging record that is about to be printed, versus displaying the exact approved version. This feature may be particularly useful for regulated industries. Upon verifying the packaging record, the user select a print mode and quantity, and print either individually, continuously, or a combination thereof. Alternatively, the user may store the generated labels to a computer-readable file in a variety of formats, such as EPS or bitmap. The user may then ship the generated label to a high-end print service for printing large volume batches.

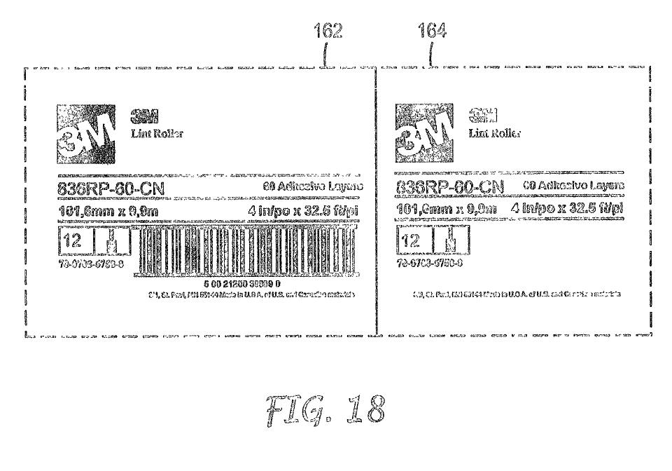

FIG. 18 illustrates two example labels 162, 164 produced by output manager 34 at an output location such as one of manufacturing facilities 6. Each label 162, 164 includes a variety of text and graphics associated with fields of a respective packaging template by a corresponding packaging record.

Various implementations and embodiments of the invention have been described. For instance, a management system for developing and managing packaging labels or other printed material for manufactured products has been described. The components of the system may be implemented as server-side components, client-side components, or a combination thereof. Nevertheless, it is understood that various modifications can be made without departing from the invention. Accordingly, these and other embodiments are within the scope of the following claims.

1. A system comprising:
a set of packaging records and associated packaging data for a plurality of products; and
a rules engine to validate the packaging records and associated data in accordance with a set of rules.

2. The system of claim 1, further comprising a record manager that controls the creation and modification of the packaging records by multiple customers, wherein the record manager includes a user interface for updating the set of rules.

3. The system of claim 2, wherein the record manager includes an interface to retrieve data from external databases, and the record manager updates the set of rules based on the retrieved data.

4. The system of claim 3, wherein the record manager retrieves regulation data from a regulatory agency, and updates the set of rules for validating the packaging records based on the regulation data.

5. The system of claim 3, wherein the record manager retrieves shipping data from a shipping company, and updates the set of rules for validating the packaging records based on the shipping data.

6. The system of claim 3, wherein the record manager retrieves customs data from customs agencies of foreign countries, and updates the set of rules for validating the packaging records based on the customers data.

7. The system of claim 3, where the interface retrieves data from databases compliant with the eXtensible Markup Language (XML).

8. The system of claim 1, further comprising an output manager that receives input from multiple customers and, based on the input, communicates the packaging records to output centers for printing of packaging materials associated with different products.

9. The system of claim 1, further comprising:
a hierarchically related set of reusable packaging templates having data fields for storing packaging data; and
a record manager that selectively presents a subset of the packaging templates to a user based on the hierarchical relationship of the packaging templates, and selects one of the presented packaging templates for creation of a new packaging record in response to input from the user.

10. The system of claim 9, further comprising a medium storing a hierarchically related set of nodes and data associating each of the set of packaging templates with at least one of the nodes.

11. The system of claim 10, further comprising a template manager that presents an interface for creating new packaging templates, and associating the new packaging templates with nodes of the hierarchy.

12. A medium comprising:
a set of packaging records and associated packaging data for a plurality of products for a plurality of customers;
a set of reusable packaging templates having data fields for creation of the packaging records in response to input from the customers; and
a set of rules for validation of the packaging records.

13. The medium of claim 12, further comprising:
a hierarchically related set of nodes; and
data associating each of the packaging templates with at least one of the nodes.

14. The medium of claim 13, further comprising data associating each of the rules with at least one of the nodes.

15. The medium of claim 12, wherein the rules conform to a data description language.

16. A system comprising:
a template manager software interface to create and manage a set of reusable packaging templates for a plurality of customers, wherein the template manager software interface registers the packaging templates against nodes of customer-defined hierarchies for organizing the packaging templates; and
a record manager software interface to create and manage a set of packaging records based on the packaging templates, wherein the record manager software interface presents subsets of the packaging templates to the customers in response to input from the customers selecting the nodes of the hierarchies.

17. The system of claim 16, further comprising an output manager software interface to presents subsets of the packaging templates to the customers in response to input from the customers selecting the nodes of the hierarchies, and to access the subsets of packaging records for printing packaging materials for products.

18. The system of claim 16, further comprising a web server to present the template manager software interface and the record manager software interface remote customers.

19. The system of claim 16, further comprising a rules engine to validate the packaging records in accordance with a set of rules.

20. The system of claim 19, wherein the record manager software interface automatically retrieves requirements data from external databases, and automatically updates the set of rules based on the requirements data.

21. The system of claim 20, wherein the requirements data comprises shipping data, regulation data, and customs data.

22. A method comprising:
hierarchically relating a set of reusable packaging templates having data fields; and
selectively presenting a subset of the packaging templates to a user based on the hierarchical relationship of the packaging templates;
selecting one of the presented packaging templates in response to input from the user; and
generating a packaging record that associates packaging data with the fields of the selected packaging template.

23. The method of claim 22, further comprising printing packaging material at one of a plurality of output locations based on the packaging record.

24. The method of claim 22, wherein hierarchically relating the packaging templates comprises:
presenting an interface to the user for defining a hierarchy having a plurality of levels and a plurality of nodes;
and associating each of the packaging templates with at least one of the nodes of the hierarchy.

25. The method of claim 22, wherein generating a packaging record comprises validating the packaging record and associated packaging data in accordance with a set of rules.

26. The method of claim 25, wherein validating the packaging record comprises:
determining field identifiers for the fields of the packaging template;
selecting rules for each field based on the respective identifier of the field; and
applying the selected rules to the packaging data associated with the fields by the packaging record.

27. The method of claim 25, further comprising updating the set of rules in response to input from a customer.

28. The method of claim 25, further comprising:
retrieving requirements data from external databases; and
updating the set of rules based on the requirements data.

29. The method of claim 28, wherein the requirements data comprises at least one of shipping data defining requirements for shipping companies, customs data defining requirements for requirements for shipping to foreign countries, and regulation data defining requirements for compliance with governmental agencies.

30. An online packaging data management system comprising:
means for centrally storing packaging templates and packaging records for a plurality of customers;
means for associating packaging data with the packaging templates;
means for validating the packaging records and associated packaging data in accordance with a set of rules defining packaging requirements;
means for controlling updates to the packaging templates and the packaging records; and
means for printing packaging materials at output locations in accordance with the packaging records.

31. The label management system of claim 30, further comprising means hierarchically arranging the packaging templates and rules.
